(19) United States
(12) Patent Application Publication
(10) Pub. No.: US 2006/0125818 A1
(43) Pub. Date: Jun. 15, 2006

(54) Image data synchronizer applied for image scaling device

(75) Inventors: Yuan-Hao Huang, Hsinchu (TW); Chiuan-Shian Chen, Hsinchu (TW); Chieh Yang, Hsinchu (TW)

Correspondence Address: BACON & THOMAS, PLLC, 625 SLATERS LANE, FOURTH FLOOR, ALEXANDRIA, VA, 22314, US

(73) Assignee: VXIS TECHNOLOGY CORP., Hsinchu (TW)

(21) Appl. No.: 11/296,439

(22) Filed: Dec. 8, 2005

(30) Foreign Application Priority Data
Dec. 14, 2004 (TW) 093138666

(51) Int. Cl. G09G 5/00

(52) U.S. Cl. 345/213; 345/660

(57) ABSTRACT

The image data synchronizer has a memory, an address write counter, an address read counter, a clock frequency modulator, and an analog/digital mixed value control oscillator. In order to prevent a read overhead to cause a disordered image, the analog/digital mixed value control oscillator is coupled to an output terminal of the clock frequency modulator to generate an output clock signal as the read clock signal for the address read counter in accordance with a clock adjustment value, so as to form the feedback compensation architecture.

### BACKGROUND OF THE INVENTION

1. Field of the Invention

The invention relates to an image data synchronizer applied for an image scaling device, and more particularly to an image data synchronizer that synchronizes the write clock signals and read clock signals by using a feedback compensation architecture.

2. Description of the Related Art

A conventional technique for image resizing is to upscale an image in both horizontal and vertical directions according to a required output format, and store the image in frame buffers constructed from memories. Then a clock rate and a clock signal are generated that are corresponding to a required time sequence in accordance to the required output format, so as to provide as a basis for reading image data from memories. In this way, data synchronization can be achieved. However, large memories as the frame buffers are required for performing the image resizing calculation processes. The chip manufacturing cost accordingly increases. Moreover, memory output/input clock rates are assumed to be at a constant proportion without considering a difference existing between the input clock rate and the clock signal, so that the resized image tends to instability. In view of the aforesaid drawbacks, an independent circuit that can generate a constant clock rate is used to avoid producing a defective image.

With reference to FIG. 10, a conventional data synchronizer comprises a time base converter 52, a memory 53 a FIFO 57, a multiplexer 58, a write control logic (WCL) circuit 55, a read control logic (RCL) circuit 56, and a sequencer and arbitration logic (SAL) circuit 54. A clock signal generator 51 is used for generating a destination clock (DCLK) signal.

The time base converter 52 is coupled to the clock signal generator 51 to receive the DCLK signal. The time base converter 52 also receives source image data and a source clock (SCLK) signal, and then adjusts the DCLK signal to synchronize the DCLK signal with the SCLK signal, so as to output destination image data.

The memory 53 as a line buffer is coupled to the time base converter 52 to store the image data output from the time base converter 53 temporarily. The sequencer and arbitration logic circuit 54 is coupled to a control terminal of the RAM 53 to determine whether the RAM 53 is enabled. The write control logic circuit 55 is coupled to the RAM 53 through the multiplexer 58 to output a write control signal to the RAM 53. Based on the write control signal, the image signal output from the time base converter 52 is transmitted to the memory 53. The read control logic circuit 56 is also coupled to the memory 53 through the multiplexer 58 to output a read control signal to the memory 53. Based on the read control signal, the image data stored in the memory 53 is read and then output to the FIFO 57. The FIFO 57 is controlled by the SAL circuit 54.

The foregoing synchronizer is implemented by writing the image data to the memory 53 temporarily and reading the image data from the memory 53. The operation is mainly controlled by the WCL circuit 55, the RCL circuit 56 and the time base converter 52. However, because the DCLK signal for the time base converter 52 is generated by an independent circuit, the DCLK signal is unable to be varied with the SCLK signals. In addition, if an accuracy design of the circuit is insufficient, the image may be disordered due to overhead in reading the data. Moreover, if the input data format varies, the synchronizer can not provide a feedback compensation and modification effect. Hence the synchronizer can not process an image noise well and even may result in an impaired image display quality.

### SUMMARY OF THE INVENTION

An image data synchronizer applied for an image scaling device in accordance with the present invention is provided to be coupled to an output terminal of a horizontal scaler. The image data synchronizer achieves an objective of synchronizing the write/read clock signals in accordance with different scales with a feedback compensation architecture, so as to ensure a high image quality.

In order to achieve the above-mentioned objective, the image data synchronizer, also having a vertical image scaling function, comprises a memory, an address write counter, an address read counter, a clock frequency modulator, and an analog/digital mixed value control oscillator.

The horizontal scaler is used to calculate horizontal image pixels and to receive clock signals, and then to generate corresponding scaled horizontal image pixels and clock signals. The image data synchronizer receives write-timing and write clock signals output by the horizontal scaler to synchronize write/read processes for the temporary stored data in the image data synchronizer. In this way, a read data rate of the image data synchronizer can be avoided being higher or lower than the write data rate of an output data rate of the horizontal scaler, so as to prevent a flickering and disordered image due to repetition read.

### BRIEF DESCRIPTION OF THE DRAWING

FIG. 1 is a block diagram of an image data synchronizer in accordance with the present invention coupled to a horizontal scaler.

FIG. 2 is a detailed block diagram of the image data synchronizer of the present invention.

FIG. 3 is a first embodiment of a clock frequency modulator of the present invention.

FIG. 4 is a chronological diagram of a write clock signal and a read clock signal of the present invention.

FIG. 5 is a second embodiment of a clock frequency modulator of the present invention.

FIG. 6 is a chronological diagram of write/read clock signals when the present invention is applied in an upscaled state.

FIG. 7 is a chronological diagram of write/read clock signals when the present invention is applied in a downscaled state.

FIG. 8 is a state diagram of writing/reading data in a memory, wherein the present invention is applied in a downscaled state without a synchronous point generating unit.

FIG. 9A shows a third embodiment of a clock frequency modulator of the present invention.

FIG. 9B shows a fourth embodiment of a clock frequency modulator of the present invention.

FIG. 10 is a block diagram of a conventional data synchronizer for upscaling an image in both horizontal and vertical directions.

### DETAILED DESCRIPTION OF THE INVENTION

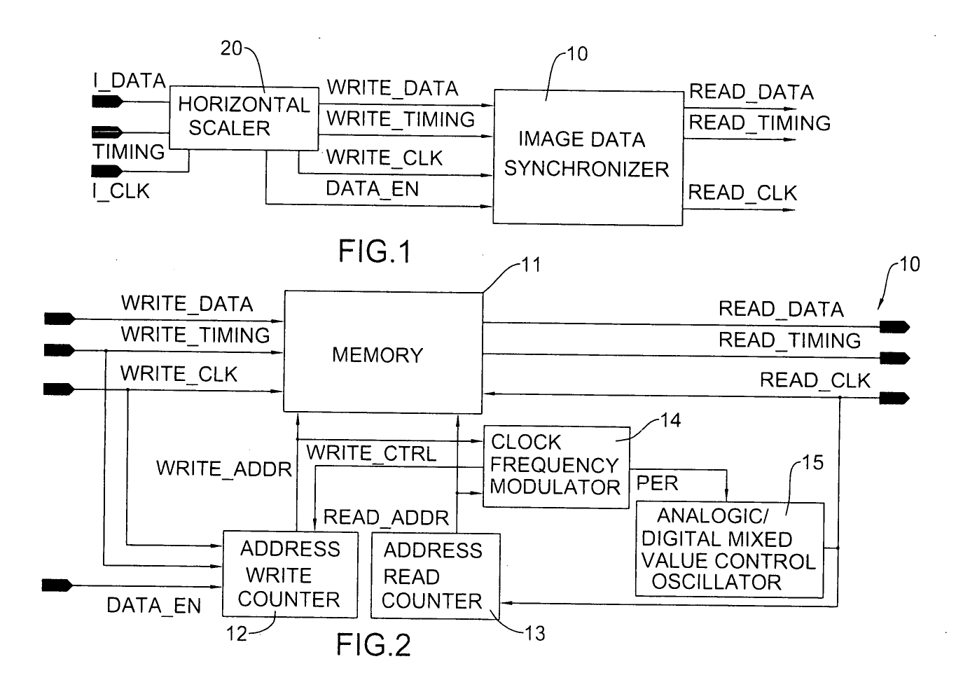

With reference to FIG. 1, an image data synchronizer 10 of the present invention having a vertical image scaling function is coupled to an output terminal of a horizontal scaler 20. The horizontal scaler 20 calculates horizontal image pixels and receives at least one clock signal, and then generates corresponding scaled horizontal image pixels and clock signals. The image data synchronizer 10 receives a write-timing signal and a write clock signal output by the horizontal scaler 20. Based on the write-timing and write clock signals, the image data synchronizer 10 synchronizes write/read processes for the image data temporarily stored in the image data synchronizer 10. In this way, a read data rate (data input rate) of the image data synchronizer 10 can be avoided being higher or lower than the write data rate (data output rate) of the horizontal scaler 20, so as to prevent a flickering and disordered image due to repetition read.

With reference to FIG. 2, the image data synchronizer 10 comprises a memory 11, an address write counter 12, an address read counter 13, a clock frequency modulator 14, and an analog/digital mixed value control oscillator 15.

The memory 11 is coupled to a data output terminal (WRITE_DATA) and a output timing terminal (WRITE_TIME) of the horizontal scaler 10 and stores image data output (WRITE_DATA) from the horizontal scaler 20.

The address write counter 12 is coupled to an address write terminal (WRITE_ADDR) of the memory 11 to determine an address in the memory 11 for storing data. The address write counter 12 receives the write clock signal output by the horizontal scaler 20. The address read counter 13 is coupled to an address read terminal (READ_ADDR) of the memory 11 to locate a target address when reading data from the memory 11.

Further, the clock frequency modulator 14 is coupled to the address write counter 12 and the address read counter 13 to receive the write address and the read address output respectively by the two counters 12,13. Based on the received write/read addresses as a feedback basis, the clock frequency modulator 14 controls data reading of the memory 11 to achieve write/read synchronization.

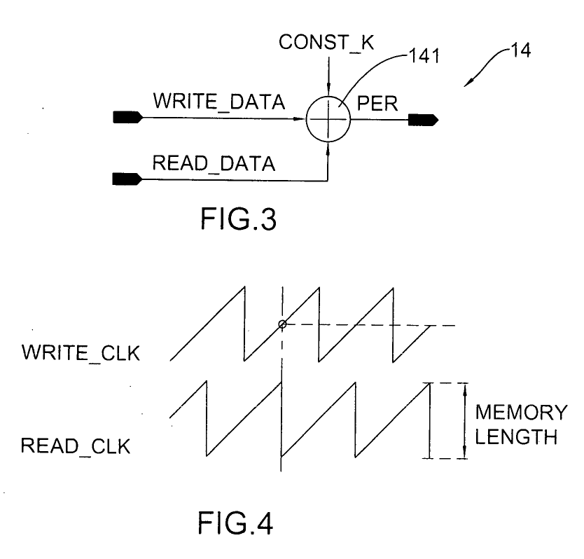

If the present invention is applied in an occasion without a vertical scale, a first embodiment of the clock frequency modulator 14 is shown in FIG. 3. A clock signal adjustment value (PER) can be produced by adding an address difference between the write address data and the read address data to a constant CONST_K. The clock frequency modulator 14 can be an adder 141. The constant CONST_K is used to ensure generating a constant address difference between the write address and the read address to prevent an overhead issue, which implies that data reading is antecedent to data writing. With reference to FIG. 4, if a frequency of the write clock signal is the same as that of the read clock signal and also a cycle time equals to writing or reading a complete data length of the memory 11, the optimal constant CONST_K is set to a value of approximately half capacity of the memory 11. That is to make the write address and the read address have a maximum distance.

Moreover, the analog/digital mixed value control oscillator 15 is coupled to an output terminal of the clock frequency modulator 14. The analog/digital mixed value control oscillator 15 generates an output clock signal as the read clock signal (READ_CLK) for the address read counter 13 based on the clock adjustment value PER, so as to form a feedback architecture.

Under the feedback architecture, the image data synchronizer 10 of the present invention can generate the read clock signal (READ_CLK) corresponding to the write clock signal (WRITE_CLK) that is inputted by the horizontal scaler 20. Therefore the read clock signal (READ_CLK) can change following the write clock signal (WRITE_CLK) to achieve synchronization. Since the write/read processes of the memory 11 can be synchronized, even if the frequency of the write clock signal (WRITE_CLK) of the horizontal scaler 20 changes, the frequency of the read clock signal (READ_CLK) also can change to avoid the disordered image issue due to a large frequency difference between the write clock signal and the read clock signal.

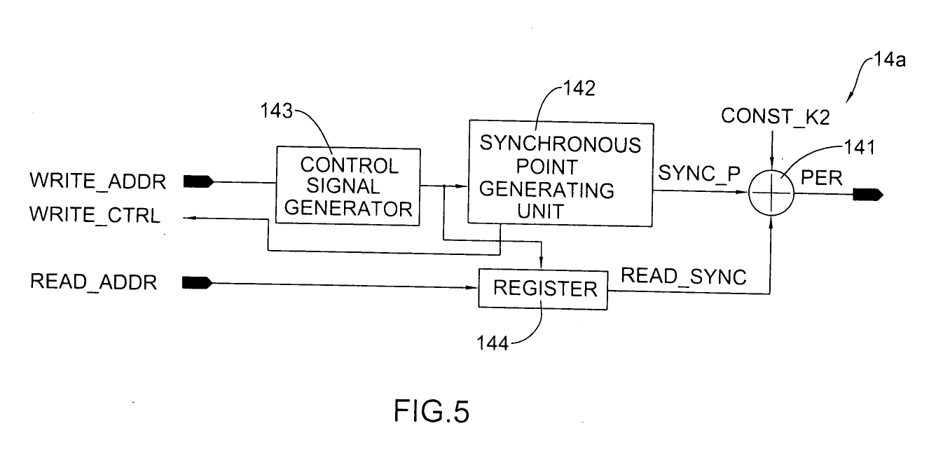

If the present invention is applied in an occasion of a vertical scale, a second embodiment of the clock frequency modulator 14 is shown in FIG. 5. Besides an adder 141, the clock frequency modulator 14a further comprises a synchronous point generating unit 142, a control signal generator 143, and a register 144.

The synchronous point generating unit 142 comprises an output terminal coupled to the input terminal of the adder 141. The control signal generator 143 is coupled to the synchronous point generating unit 142 and the address output terminal (WRITE_ADDR) of the address write counter 12. The register 144 comprises an input terminal coupled to an output terminal (READ_ADDR) of the address read counter 13 for temporary storing the read address in accordance with a chronological control of the control signal generator 143. The register 144 then can output the temporary stored read address to the input terminal of the adder 141. The register 144 can be a flip-flop.

Moreover, the synchronous point generating unit 142 is pre-stored with multiple synchronous adjustment signals for different scales for sequential sending out when triggered, so as to achieve synchronization in the vertical scale occasion. Since the synchronous adjustment signals is designed for different image scales, the read overhead which only occurs when the image is enlarged can be constrained to occur just in a horizontal blanking interval. Thereby the visible image will not be flickering and disordered.

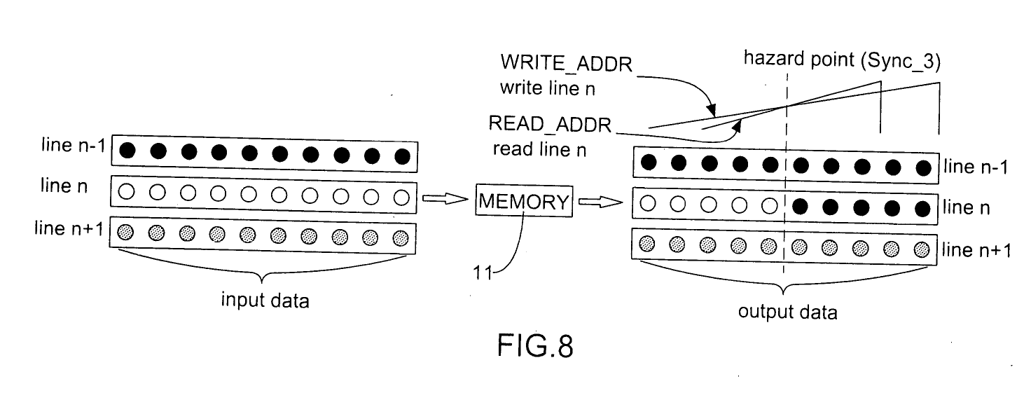

Furthermore, a repetition read can be illustrated in FIG. 8. The left part of FIG. 8 shows input data comprising line n−1, line n, and line n+1 to be written to the memory 11, and the right part of FIG. 8 shows each cycle time of the output data of the memory in accordance with the read clock signal. Since the reading speed is faster than the writing speed, when reading a later half of the second data line n, the memory 11 does not finish writing the previous line n−1. Thereby the later half of the data line n−1 is read again, so as to cause the repetition read and result in a data disordered issue. The right above part of the diagram shows a cross point of waveforms of the write and read processes, which is a “hazard point” of so-called read overhead. The present invention is to make use of the settings of the synchronous adjustment signals to have the hazard point occur only within the horizontal blanking interval.

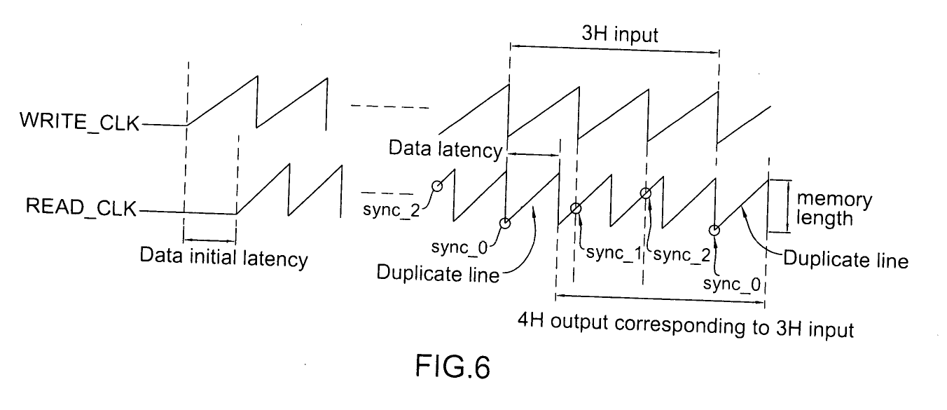

With reference to FIG. 6, a contrast diagram of the write/read clock signals is shown when the present invention is applied in a vertical upscaled process for enlarging 4/3 times. When every write address is generated as shown in FIG. 5, the synchronous point generating unit 142 of the clock frequency modulator 14a will be triggered to output a predetermined sequence such as the defined three synchronous points of sync_1, sync_2, and sync_0, and also the register 144 is simultaneous triggered. At this moment, the read address is sent to the adder 141 to calculate the address difference and then to send the address difference to a subsequent circuit (not shown in the diagram) to perform a feedback compensation. In the second example of the second preferred embodiment of the present invention, a constant value CONST_K2 is only provided for compensation to make the address difference approach to zero, which does not require using the constant CONST_K2 in a general situation. Three cycle time periods of the write clock signal can be synchronized with four cycle time periods of the read clock signal by the feedback compensation method to synchronize the synchronous points of sync_1, sync_2, and sync_0, so as to achieve the synchronization.

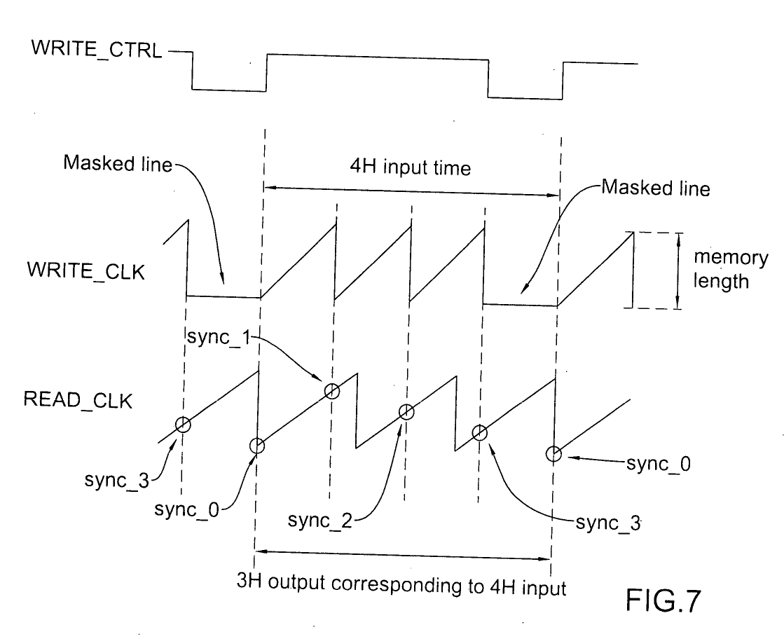

With reference to FIG. 7, a contrast diagram of the write/read clock signals is shown when the present invention is applied in a vertical downscaled process for shrinking ¾ time. When every write address is generated as shown in FIG. 5, the synchronous point generating unit 142 will be triggered to output a predetermined sequence such as the defined four synchronous points of sync_0, sync_1, sync_2, and sync_3, and also the register 144 is simultaneous triggered. Four cycle time periods of the write clock signal can be synchronized with three cycle time periods of the read clock signal by the feedback compensation method to synchronize the synchronous points of sync_0, sync_1, sync 2, and sync_3, so as to achieve the synchronization.

Moreover, when processing the vertical downscaled image, a write control signal WRITE_CTRL is used to avoid the repetition read issue. When the synchronous point generating unit 142 generates the synchronous point sync_3, the address write counter 12 of FIG. 2 will not write data to the memory 11 temporarily, so that the write address will not be output. As shown in FIG. 7, a masked line is appeared in the synchronous point sync_3 corresponding to a low electric potential of the write control signal WRITE_CTRL, so that no data will be written to the memory 11. In this way, the data lines of the read clock signal can be read completely.

It can be understood from the above description that the image data synchronizer of the present invention utilizes the write address and the read address of the memory to generate the write clock signal the read clock signal. Then the read clock signal can be assured to be synchronized with the write clock signal by the feedback compensation architecture. Moreover, in addition to synchronize the data reading and writing processes, the present invention further comprises the vertical scaling function by having the frequency of the read clock signal be proportionate to the frequency of the write clock signal. In order to prevent a disordered image due to the repetition read when the frequency varies, the synchronous point generating unit is used to achieve the synchronization when processing the vertical scaling image.

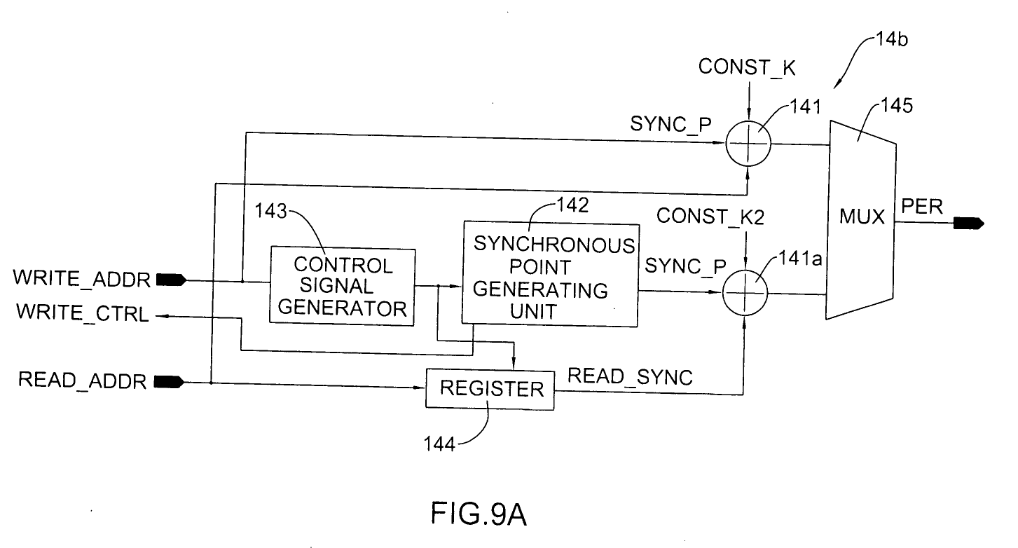

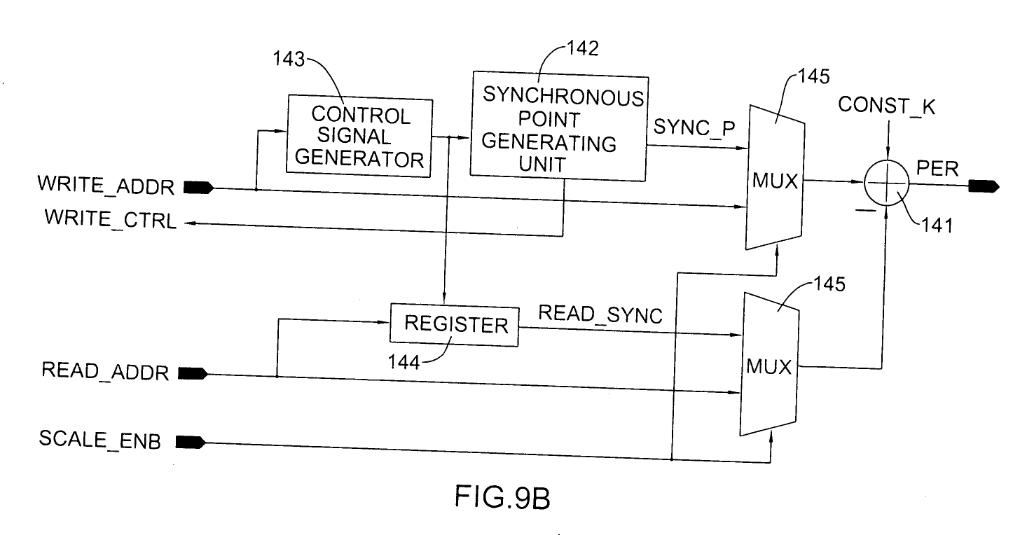

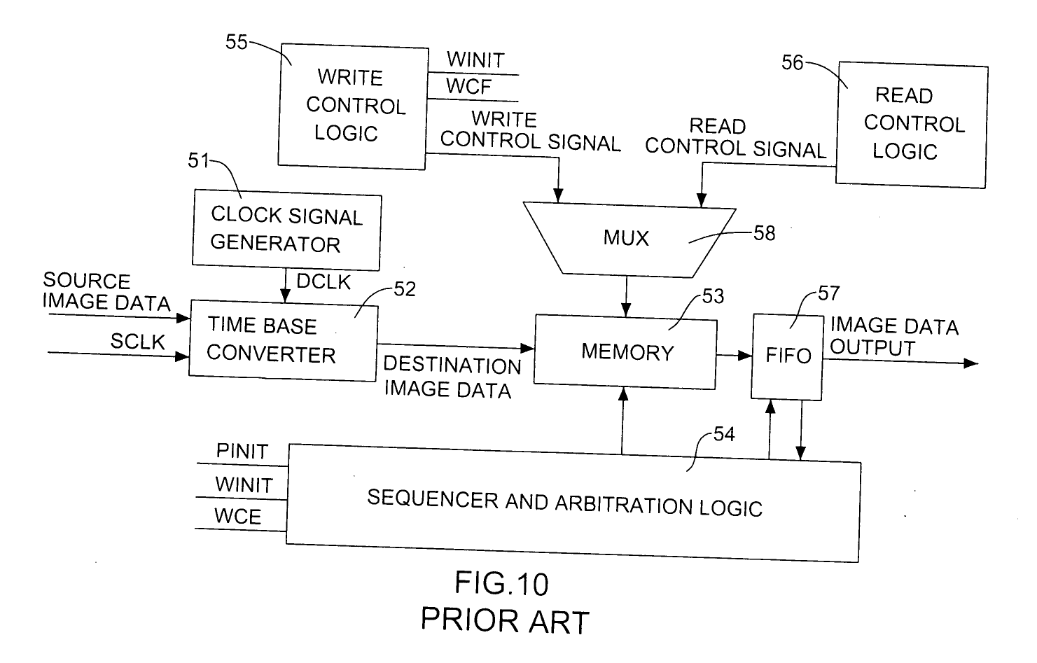

With reference to FIG. 9A, a third embodiment of the clock frequency modulator 14b of the present invention can integrate circuits of FIG. 3 and FIG. 5 by using a multiplexer 145. When the present invention is used to synchronize the data reading and writing processes of the memory 11, the multiplexer 145 is controlled to select the adjustment value output by a first adder 141. On the other hand, when the present invention is used to process the vertical scaling function, the multiplexer 145 is controlled to select the adjustment value output by a second adder 141a. In this way, the present invention can implement the dual functions of the synchronizing adjustment and the vertical scaling process. With the similar method, the present invention also can be implemented by using two multiplexers 145 as signal selectors and one adder 141, which is shown in FIG. 9B to construct a fourth embodiment.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image data synchronizer, which is connected to an output terminal of an image horizontal scaler, wherein the image horizontal scaler generates scaled pixels and at least one clock signal to the image data synchronizer, wherein the image data synchronizer comprises:
a memory coupled to a data output terminal and a chronological output terminal of the horizontal scaler for temporary storing data output from the horizontal scaler;
an address write counter coupled to an address write terminal of the memory to determine an address in the memory for storing data;
an address read counter coupled to an address read terminal of the memory to determine a read sequence in the memory;
a clock frequency modulator coupled to the address write counter and the address read counter to receive a write address and a read address output by the address write counter and the address read counter and to compute an adjustment value for a read clock signal of the address read counter; and
an analog/digital mixed value control oscillator coupled to an output terminal of the clock frequency modulator to generate the read clock signal for the address read counter in accordance with the clock adjustment value.

2. The image data synchronizer as claimed in claim 1, wherein the clock frequency modulator is an adder comprising an input terminal coupled to address output terminals of the address write counter and the address read counter to receive an address difference of the write address and the read address, and an output terminal coupled to the analog/digital mixed value control oscillator.

3. The image data synchronizer as claimed in claim 2, wherein the adder is further configured with an additional input terminal for inputting an address constant to the adder to stabilize a data reading process.

4. The image data synchronizer as claimed in claim 3, wherein the address constant is set to a value of approximately half capacity of the memory.

5. The image data synchronizer as claimed in claim 2, wherein the clock frequency modulator further comprises:
a synchronous point generating unit comprising an output terminal coupled to the input terminal of the adder, wherein the synchronous point generating unit pre-stores multiple synchronous adjustment signals for different scales for sequential sending out when triggered;
a register comprising an input terminal coupled to an output terminal of the address read counter for temporary storing the read address output by the address read counter, the register outputting the temporary stored read address to the input terminal of the adder when triggered; and
a control signal generator coupled to the synchronous point generating unit and the address output terminal of the address write counter, wherein when an output address of the address write counter is zero, the synchronous point generating unit and the register are triggered to output data for synchronously adjusting the write/read clock signals.

6. The image data synchronizer as claimed in claim 5, wherein the synchronous adjustment signals of the synchronous point generating unit generate a sequence in accordance with different vertical scales.

7. The image data synchronizer as claimed in claim 1, wherein the clock frequency modulator further comprises:
a first adder comprising an input terminal coupled to address output terminals of the address write/read counters to receive an address difference of the write address and the read address;
a second adder for calculating the address difference of the write address and the read address;
a synchronous point generating unit comprising an output terminal coupled to an input terminal of the second adder, wherein the synchronous point generating unit is used to generate multiple synchronous adjustment signals;
a register comprising an input terminal coupled to an output terminal of the address read counter for temporary storing the read address output by the address read counter, which can output the temporary stored read address to the input terminal of the second adder when triggered;
a control signal generator coupled to the synchronous point generating unit and the address output terminal of the address write counter, wherein when an output address of the address write counter is zero, the synchronous point generating unit and the register are triggered to output data for synchronously adjusting the write/read clock signals; and
a multiplexer coupled to the first adder, the second adder and an analog/digital mixed value control oscillator to selectively receive the adjustment value output from the first adder or the second adder.

8. The image data synchronizer as claimed in claim 7, wherein the clock frequency modulator further comprises:
a first multiplexer comprising an input terminal coupled to address output terminals of the address write/read counters to receive an address difference of the write address and the read address;
a second multiplexer for calculating the address difference of the write address and the read address;
a synchronous point generating unit comprising an output terminal coupled to an input terminal of the second multiplexer, wherein the synchronous point generating unit is used to generate multiple synchronous adjustment signals;
a register comprising an input terminal coupled to an output terminal of the address read counter for temporary storing the read address output by the address read counter, which can output the temporary stored read address to the input terminal of the second multiplexer when triggered;
a control signal generator coupled to the synchronous point generating unit and the address output terminal of the address write counter, wherein when an output address of the address write counter is zero, the synchronous point generating unit and the register are triggered to output data for synchronously adjusting the write/read clock signals; and
an adder coupled to the first multiplexer, the second multiplexer and an analog/digital mixed value control oscillator to receive the adjustment value output from the first adder and the second adder.

9. The image data synchronizer as claimed in claim 7, wherein each of the adder further has an additional input terminal for inputting an address constant to stabilize a data reading process.

10. The image data synchronizer as claimed in claim 8, wherein the address constant is set to a value of approximately half capacity of the memory.

11. The image data synchronizer as claimed in claim 7, wherein the synchronous adjustment signals of the synchronous point generating unit produce a sequence in accordance with different vertical scales.
